(19) United States
(12) Patent Application Publication
(10) Pub. No.: US 2026/0038036 A1
(43) Pub. Date: Feb. 5, 2026

(54) ADAPTIVE FRAUD DETECTION SYSTEM

(71) Applicant: RAPTORXAI PRIVATE LIMITED, Tellapur (IN)

(72) Inventor: Pratyusha Vemuri Venkata, Tellapur (IN)

(21) Appl. No.: 19/288,888

(22) Filed: Aug. 1, 2025

(30) Foreign Application Priority Data
Aug. 4, 2024 (IN) 202441058870

(51) Int. Cl. G06Q 40/02; G06N 3/044

(52) U.S. Cl. CPC G06Q 40/024; G06N 3/044

(57) ABSTRACT

The present invention relates to an adaptive fraud detection system and method that leverages customer feedback and advanced machine learning techniques. The system comprises an upload interface for receiving customer-provided data on suspected fraudulent activities, an OCR module for extracting textual information from the data, a data analysis unit for generating fraud detection features, a feature repository for managing these features, a Graph Recurrent Neural Network (GraphRNN) model for predicting fraud patterns, a decision-making module for integrating component outputs, and an alert generation unit for issuing fraud alerts. The method involves receiving and securing customer data, extracting text using OCR, analyzing the text to generate fraud features, updating the feature repository, constructing graph representations of transactions, applying the GraphRNN model for fraud prediction, and generating alerts based on the predictions.

### FIELD OF THE INVENTION

The invention pertains to the field of fraud detection and prevention systems. Specifically, the invention relates to adaptive fraud detection systems and methods that utilize customer feedback, optical character recognition (OCR), and Graph Recurrent Neural Networks (GraphRNNs) to improve the detection and prediction of fraudulent activities by dynamically incorporating real-time data and complex relational patterns.

### BACKGROUND OF THE INVENTION

Fraud detection systems have become essential in various industries, particularly in financial services, due to the increasing prevalence of sophisticated fraudulent activities. However, existing systems face several critical challenges that hinder their effectiveness and efficiency.

One major problem is the reliance on static fraud detection models. These models are typically built on historical data and predefined rules that do not adapt well to new and evolving fraud patterns. As fraudsters continuously develop new techniques, static models quickly become outdated, leading to increased false positives and false negatives in fraud detection.

Another significant issue is the limited feature sets employed by current fraud detection systems. These systems often use a fixed set of features derived from historical data, which restricts their ability to identify novel fraud patterns. The rigid feature frameworks are insufficient for capturing the complexity and diversity of modern fraudulent activities.

The lack of real-time customer feedback integration poses another challenge. Many fraud detection systems do not incorporate customer-reported incidents into their detection processes promptly. This delay in integrating real-time feedback prevents the system from quickly adapting to new fraud tactics, leaving a gap in the detection and response mechanism.

Furthermore, existing systems struggle with the efficient processing of unstructured data. Fraudulent activities often involve unstructured textual data from various sources, such as emails, social media, and customer complaints. Current systems lack advanced capabilities to process and analyze this data effectively, limiting the scope of information used for fraud detection.

Traditional fraud detection methods also fail to capture complex temporal and relational patterns in fraudulent activities. Fraud often involves intricate networks of transactions that evolve over time, and current methods are not equipped to identify these complex relationships and temporal changes, leading to missed fraud cases.

Scalability is another pressing issue. As the volume of transactions and data points grows, many fraud detection systems face performance challenges. They become less efficient and more prone to errors, resulting in decreased accuracy and increased false positives and negatives. Scalability problems also hinder the ability of these systems to operate effectively in large-scale environments.

Additionally, the high rate of false positives generated by current systems is a significant concern. False positives, where legitimate transactions are flagged as fraudulent, cause inconvenience to customers and operational burdens on organizations. High false positive rates erode customer trust and satisfaction, as well as increase the cost of manual reviews.

The inefficiency in detecting and responding to new fraud patterns is further exacerbated by the lack of a proactive approach in existing systems. Most fraud detection methods are reactive, identifying fraud after it has occurred rather than predicting and preventing it. This reactive nature results in financial losses and reputational damage for organizations before any action can be taken.

Lastly, regulatory compliance is a growing concern. With evolving regulations around fraud prevention and financial security, existing systems often struggle to meet these stringent requirements. Inadequate fraud detection capabilities can lead to non-compliance, resulting in legal penalties and further financial losses for organizations.

### SUMMARY OF THE INVENTION

To address the foregoing problems, in whole or in part, and/or other problems that may have been observed by persons skilled in the art, the present disclosure provides compositions and methods as described by way of example as set forth below.

The principal object of the present invention is to develop an adaptive fraud detection system that utilizes customer feedback, OCR, and Graph Recurrent Neural Networks (GraphRNNs) to dynamically detect and predict fraudulent activities with high accuracy.

Another object of the invention is to enhance the fraud detection capabilities by incorporating real-time customer feedback, enabling the system to quickly adapt to new and evolving fraud patterns.

Another object of the invention is to improve the processing and analysis of unstructured textual data from various sources, such as emails and social media, using advanced OCR and natural language processing (NLP) techniques.

Another object of the invention is to effectively capture and analyze complex temporal and relational patterns in fraudulent activities through the use of GraphRNN models, ensuring comprehensive detection of intricate fraud networks.

Another object of the invention is to reduce the rate of false positives and false negatives in fraud detection, thereby improving customer trust and satisfaction while decreasing the operational burden on organizations.

In view of the foregoing, the present invention provides a fraud detection system, comprising: an upload interface configured to receive customer-provided data related to suspected fraudulent activities; an optical character recognition (OCR) module configured to extract textual information from the received data; a data analysis unit configured to analyze the extracted text and generate fraud detection features; a feature repository for storing and managing the fraud detection features; a Graph Recurrent Neural Network (GraphRNN) model configured to predict fraud patterns using the stored features and historical data; a decision-making module configured to combine outputs from multiple system components; and an alert generation unit configured to issue alerts based on the final fraud detection results.

In another aspect of the present invention, the invention discloses a fraud detection system, comprising an upload interface configured to receive customer-provided data related to suspected fraudulent activities, an optical character recognition (OCR) module configured to extract textual information from the received data, a data analysis unit configured to analyze the extracted text and generate fraud detection features, a feature repository for storing and managing the fraud detection features, a Graph Recurrent Neural Network (GraphRNN) model configured to predict fraud patterns using the stored features and historical data, a decision-making module configured to combine outputs from multiple system components, and an alert generation unit configured to issue alerts based on the final fraud detection results.

In another aspect of the present invention, the upload interface includes secure web portals and API endpoints to ensure secure data transmission.

In another aspect of the present invention, the OCR module is enhanced with machine learning algorithms for improved text extraction accuracy.

In another aspect of the present invention, the data analysis unit employs natural language processing (NLP) techniques to interpret the textual information for fraud pattern identification.

In another aspect of the present invention, the GraphRNN model uses attention mechanisms to prioritize significant parts of the input data for accurate fraud pattern prediction.

In an another embodiment, the invention provides a method for detecting fraudulent activities, comprising, receiving data related to suspected fraud from customers, extracting textual information from the received data using OCR technology, analyzing the extracted text to identify and generate fraud detection features, updating a feature repository with the newly identified features, constructing a graph representation of financial transactions and entities using the updated features, applying a GraphRNN model to the constructed graph to predict potential fraud patterns, and generating alerts based on the predictions from the GraphRNN model.

Additional features of the invention will be or will become apparent to one with skill in the art upon examination of the following FIGURES and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates a system Design of Adaptive Fraud Detection System Using Customer Feedback and GraphRNN Analysis, in accordance with an embodiment of the present invention;

Skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The present invention provides an advanced fraud detection system and method that significantly enhances the ability to identify and predict fraudulent activities. The system uses a combination of customer feedback, optical character recognition (OCR), and Graph Recurrent Neural Networks (GraphRNNs) to dynamically adapt to new fraud patterns and improve detection accuracy. By integrating real-time data from customers and advanced machine learning techniques, the invention addresses the limitations of existing static fraud detection models.

The fraud detection system comprises several key components: an upload interface for receiving customer-provided data, an OCR module for extracting textual information from this data, a data analysis unit for generating and updating fraud detection features, a feature repository for managing these features, a GraphRNN model for predicting fraud patterns, a decision-making module for combining outputs from different components, and an alert generation unit for issuing fraud alerts. This modular architecture ensures that the system can efficiently process diverse data types and adapt to evolving fraud tactics.

The method for detecting fraudulent activities involves several steps: receiving and securing customer data, extracting text using OCR, analyzing the text to generate fraud detection features, updating the feature repository, constructing graph representations of transactions and entities, applying the GraphRNN model to predict potential fraud patterns, and generating alerts based on these predictions. This method allows for continuous improvement and adaptation of the fraud detection system, ensuring high accuracy and timely responses to new fraud schemes.

By incorporating customer feedback and utilizing advanced machine learning models, the invention significantly reduces the rate of false positives and false negatives. This not only improves customer satisfaction and trust but also reduces the operational burden on organizations by minimizing the need for manual reviews. Additionally, the system's ability to process unstructured data and capture complex temporal and relational patterns ensures comprehensive fraud detection coverage.

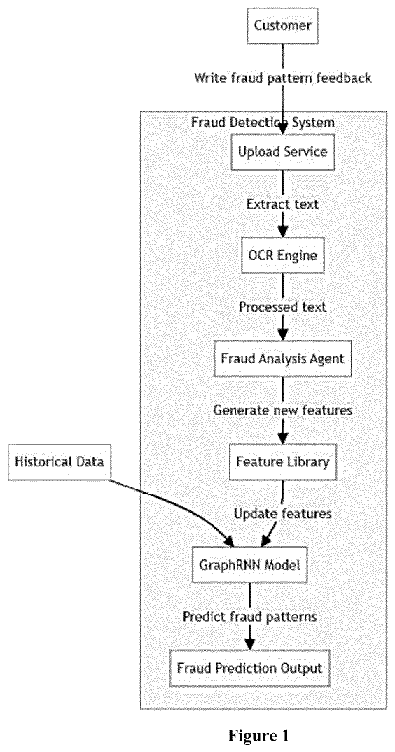

In accordance with an embodiment of the present invention, FIG. 1 illustrates a system Design of Adaptive Fraud Detection System Using Customer Feedback and GraphRNN Analysis. The FIGURE depicts the system design of an adaptive fraud detection system that incorporates customer feedback and Graph Recurrent Neural Network (GraphRNN) analysis. The system consists of several integrated components. The upload interface is designed to receive data related to suspected fraudulent activities from customers. This interface supports various formats and ensures secure data transmission. The optical character recognition (OCR) module extracts textual information from the uploaded data by converting different types of documents and images into machine-readable text. The data analysis unit processes the extracted text to identify and generate relevant fraud detection features, utilizing natural language processing (NLP) and other analytical techniques. These identified features are stored and managed in a centralized database known as the feature repository, which supports versioning and efficient retrieval of features.

The GraphRNN model constructs a graph representation of financial transactions and entities using the stored features and applies recurrent neural network techniques to predict potential fraud patterns. The decision-making module combines outputs from the OCR module, data analysis unit, and GraphRNN model to make final decisions regarding the likelihood of fraudulent activities. Based on the decision-making module's output, the alert generation unit generates alerts to notify relevant stakeholders of potential fraud, supporting various alerting mechanisms, including emails, SMS, and dashboard notifications. This system design enhances the accuracy and adaptability of fraud detection by leveraging advanced machine learning techniques and real-time customer feedback.

In an embodiment, the system begins with the Upload Service, which includes a secure web interface and API endpoints for receiving customer feedback on suspected fraudulent activities. This service ensures data security during transmission through encryption protocols and manages high volumes of incoming data with a queueing system. Once data is received, the Optical Character Recognition (OCR) Engine extracts textual information from various document formats using advanced OCR algorithms and machine learning-based image preprocessing. The OCR Engine supports multiple languages and character sets to handle diverse customer inputs.

Following text extraction, the Fraud Analysis Agent takes over, utilizing Natural Language Processing (NLP) techniques to interpret the extracted text and identify potential fraud patterns. This agent combines rule-based systems with machine learning models for initial fraud detection and incorporates a feedback loop to continuously improve its capabilities. The identified features are then managed by the Feature Library, a scalable database system that stores and organizes fraud detection features. This library includes a versioning system to track changes and allows for rollbacks if necessary, and provides a real-time API for feature retrieval and updates.

The core of the system is the Graph Recurrent Neural Network (GraphRNN) Model, which uses a specialized architecture for predicting fraud patterns through graph-based representations. The model constructs dynamic graphs to represent complex relationships between entities and employs attention mechanisms to focus on relevant parts of the input graph. The Weighted System then integrates outputs from various components, utilizing an adaptive weighting mechanism to balance inputs and dynamically adjust weights based on system performance and evolving fraud patterns.

Finally, the Output Module consolidates predictions from the GraphRNN Model and other fraud detection methods, applying final decision logic to generate alerts and reports. This module provides customizable reporting interfaces for stakeholders and implements alert mechanisms for high-priority fraud predictions. The system's continuous workflow involves ingesting customer feedback, extracting and analyzing text, updating the Feature Library, constructing and analyzing graphs, generating predictions, and disseminating results. Feedback on prediction accuracy is collected to refine the system, ensuring it adapts rapidly to new fraud patterns while leveraging historical data and complex relational information.

Some of the non-limiting advantages of the present invention are:
Enhanced Fraud Detection Accuracy: By integrating real-time customer feedback and employing advanced machine learning techniques, the system significantly improves fraud detection accuracy, reducing both false positives and false negatives.
Rapid Adaptation to New Fraud Patterns: The system's ability to quickly incorporate and analyze new fraud patterns reported by customers allows for swift adaptation to evolving fraudulent activities, staying ahead of sophisticated fraud schemes.
Improved Customer Trust and Satisfaction: By actively involving customers in the fraud detection process and quickly acting on their feedback, the system enhances customer trust and satisfaction with the fraud prevention measures.
Reduced Financial Losses: The proactive and adaptive nature of the system leads to earlier detection and prevention of fraudulent activities, significantly reducing potential financial losses for both the implementing organization and its customers.
Scalable Fraud Detection: The system's architecture allows for efficient processing of large volumes of data, making it scalable to meet the needs of growing organizations and increasing transaction volumes.
Comprehensive Fraud Analysis: By leveraging GraphRNN technology, the system can identify complex, interconnected fraud patterns that might be missed by traditional methods, providing a more comprehensive fraud detection capability.
Reduced Manual Intervention: The automated nature of feature generation and model updating reduces the need for constant manual intervention, allowing fraud detection teams to focus on high-level strategy and complex cases.
Improved Regulatory Compliance: The system's advanced fraud detection capabilities and detailed audit trails help organizations better comply with evolving regulatory requirements related to fraud prevention and financial security.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed is:

1. A fraud detection system, comprising:
an upload interface configured to receive customer-provided data related to suspected fraudulent activities;
an optical character recognition (OCR) module configured to extract textual information from the received data;
a data analysis unit configured to analyze the extracted text and generate fraud detection features;
a feature repository for storing and managing the fraud detection features;
a Graph Recurrent Neural Network (GraphRNN) model configured to predict fraud patterns using the stored features and historical data;
a decision-making module configured to combine outputs from multiple system components; and
an alert generation unit configured to issue alerts based on the final fraud detection results.

2. The system as claimed in claim 1, wherein the upload interface includes secure web portals and API endpoints to ensure secure data transmission.

3. The system as claimed in claim 1, wherein the OCR module is enhanced with machine learning algorithms for improved text extraction accuracy.

4. The system as claimed in claim 1, wherein the data analysis unit employs natural language processing (NLP) techniques to interpret the textual information for fraud pattern identification.

5. The system as claimed in claim 1, wherein the feature repository includes version control to manage updates and revisions of the fraud detection features.

6. The system as claimed in claim 1, wherein the GraphRNN model uses attention mechanisms to prioritize significant parts of the input data for accurate fraud pattern prediction.

7. The system as claimed in claim 1, wherein the decision-making module dynamically adjusts weights assigned to the outputs from different components based on their performance metrics.

8. The system as claimed in claim 1, wherein the alert generation unit provides customizable reporting interfaces tailored to different stakeholders.

9. A method for detecting fraudulent activities, comprising:
receiving data related to suspected fraud from customers;
extracting textual information from the received data using OCR technology;
analyzing the extracted text to identify and generate fraud detection features;
updating a feature repository with the newly identified features;
constructing a graph representation of financial transactions and entities using the updated features;
applying a GraphRNN model to the constructed graph to predict potential fraud patterns; and
generating alerts based on the predictions from the GraphRNN model.

10. The method as claimed in claim 9, further comprising securing the received data using encryption protocols during transmission.

11. The method as claimed in claim 9, wherein the OCR technology is configured to support multiple languages and character sets to process diverse customer inputs.

12. The method as claimed in claim 9, further comprising incorporating real-time customer feedback into the analysis to continuously update the fraud detection features.

13. A non-transitory computer-readable medium storing instructions that, when executed by a processor, cause the processor to perform the method of claim 9.
